(19) United States
(12) Patent Application Publication
(10) Pub. No.: US 2003/0066239 A1
(43) Pub. Date: Apr. 10, 2003

(54) Portable cogeneration fuel-cell power generator with high-yield, low pressure reformer for recreational vehicles

(76) Inventor: Iraj Parchamazad, La Verne, CA (US)

Correspondence Address: A. M. Fernandez, 2933 Motor Avenue, Los Angeles, CA, 90064, US

(21) Appl. No.: 09/973,287

(22) Filed: Oct. 5, 2001

(51) Int. Cl. B01J 8/00

(52) U.S. Cl. 48/127.9; 48/198.6; 48/198.7; 422/211; 422/227; 429/17; 429/19

(57) ABSTRACT

A steam reformer for producing H₂ from a low pressure hydrocarbon gas (preferably propane) using an improved gaseous hydrocarbon fuel and steam delivery system comprising two coaxial tubes, an outer tube for delivery of steam which is gradually reduced in diameter to form a truncated conical tip for the outflow of steam around the end of an inner tube for the outflow of gaseous hydrocarbon. The outflow ends of both tubes are positioned in the same plane perpendicular to their axis. The outflow end of the second tube is preferably also gradually reduced in diameter in order to provide higher velocity of gaseous hydrocarbon to be mixed with the steam entering the reformer for optimized yield of hydrogen by optimizing the mixing of the steam and gaseous hydrocarbon in order to optimize the yield of hydrogen for the optimized generation of wattage for the same fuel-cell power generating system.

### FIELD OF THE INVENTION

The invention relates to a hydrogen fuel-cell power generator, and more particularly to such a generator with a reformer comprising a catalytic converter having an improved delivery system of low pressure gaseous propane (or other hydrocarbon gas) and high pressure steam to be converted to hydrogen with high yield.

### BACKGROUND OF THE INVENTION

There is an expanding need for portable fuel-cell power generators, such as for use on recreational vehicles (RVs). The most promising fuel cell uses a proton-exchange membrane (PEM) which operates on hydrogen produced in a reformer by catalytic reaction with gaseous hydrocarbon fuel, such as propane mixed with steam. While a hydrogen rich gas is produced, carbon monoxide and carbon dioxide are also present in the outflow of the reformer It is important to produce a high yield of hydrogen in the outflow of the reformer in order to reduce the amount of carbon monoxide relative to the hydrogen yield because carbon monoxide deactivates the PEM cell.

Although there has been significant research and development of fuel cells for power generation, both stationary as well as portable for automotive drive power, there are other significant needs for portable fuel-cell power generation, such as aboard recreational vehicles (RVs) for nonautomotive drive applications, e.g., lighting, cooking, refrigeration, television and air conditioning in motor homes. Most motor homes are presently equipped with a storage tank of liquified propane for some of these purposes and equipped with a gasoline/diesel/propane internal combustion engine to power an electrical generator for other purposes, including air conditioning, but such powered generators are noisy, which is a major problem with gasoline powered generators when run in an RV park.

In a marine RV, such as a houseboat on a lake, the gasoline powered engine for the electric generator is usually mounted below deck for convenience in cooling the gasoline engine with lake water. Although the engine exhaust is vented through or over the water, some of the engine exhaust may nevertheless accumulate in the houseboat. Any carbon monoxide exhaust that may accumulate in or around the houseboat presents a life threatening pollution, and it is impractical to run the engine exhaust through a purifier.

On the other hand, a portable fuel-cell generator for an RV using liquified propane from a tank typically provides low pressure gaseous propane that is then coupled into one end of a small steel cylinder loosely packed with a catalyst through a tube, typically of small diameter (⅛″ ). Steam is also coupled into that one end of the cylinder at high pressure from a steam generator through a tube, typically of larger diameter (¼″ ), situated proximate the tube of small diameter. Steam flowing past the end of the small diameter tube draws the gaseous fuel into the cylinder of the reformer where it immediately mixes with the steam and passes over the catalyst as it flows toward an outlet tube at the other end of the cylinder, as described in copending application Ser. No. 09/531,137. Any carbon monoxide and carbon dioxide produced by the converter is removed by passing the outflow of the converter through a purifier before introducing the hydrogen into the fuel cell.

A preferred catalyst for producing hydrogen from steam and gaseous hydrocarbon fuel is one that is holmium based because in its presence the carbon monoxide produced in the reaction of the fuel and steam with the catalyst is in a very low concentration, as described in copending application Ser. No. 09/537,903. However, other suitable catalysts may be used to produce a gas rich in hydrogen for use in a fuel cell. In any case the yield of hydrogen necessary for producing electricity in the fuel cell from the hydrocarbon fuel is typically limited to generating 500 watts in the system of the aforesaid copending application Ser. No. 09/537,903 due to insufficient hydrogen production.

The problem then is to provide electrical power generation free of air pollution as well as noise pollution using a hydrogen fuel-cell generator system, that is not limited in wattage regardless of size due to insufficient hydrogen production. That problem arises from the inefficient conversion of gaseous hydrocarbon into hydrogen at a higher yield rate for the size of the reformer. In essence, the motivation for this invention is to optimize the yield of hydrogen produced for a fuel cell through a reformer of a given size.

### STATEMENT OF THE INVENTION

In accordance with the present invention, a low-pressure gaseous hydrocarbon fuel mixed with steam is converted in a reformer into hydrogen, carbon monoxide and carbon dioxide to produce hydrogen at a maximized high-yield rate for fueling a PEM fuel-cell power generator via a purifier by using an improved gaseous hydrocarbon fuel and steam delivery system comprising two coaxial tubes, an outer tube for delivery of steam which is gradually reduced in diameter to form a truncated conical tip for the outflow of steam around the end of an inner tube for the outflow of gaseous hydrocarbon. The outflow ends of both tubes are positioned in the same plane perpendicular to their axis. The outflow end of the second tube is preferably also gradually reduced in diameter in order to provide higher velocity of gaseous hydrocarbon to be mixed with the steam entering the reformer for optimized yield of hydrogen by optimizing the mixing of the steam and gaseous hydrocarbon in order to optimize the yield of hydrogen for the optimized generation of wattage for the same fuel-cell power generating system.

The novel features that are considered characteristic of this invention are set forth with particularity in the appended claims. The invention will best be understood from the following description when read in connection with the accompanying drawings.

### BRIEF DESCRIPTION OF THE DRAWINGS

FIG. 1 is a block diagram of a fuel-cell system utilizing a reformer in accordance with the present invention for high-yield production of hydrogen gas from low-pressure hydrocarbon fuel, such as liquified propane stored in a tank that gives off vapor fuel at a low pressure which is then mixed with steam at a high pressure through a fuel delivery system to the reformer cylinder packed with a catalyst.

FIG. 2 is a schematic diagram of the reformer of FIG. 1 utilizing coaxial tubes for the delivery system of steam and gaseous hydrocarbon.

FIG. 3 is an enlarged view of the outflow ends of the coaxial tubes comprising the fuel delivery system showing the momentum vectors of the annular flow of steam converging on the gaseous hydrocarbon outflow from the system.

### DETAILED DESCRIPTION OF THE INVENTION

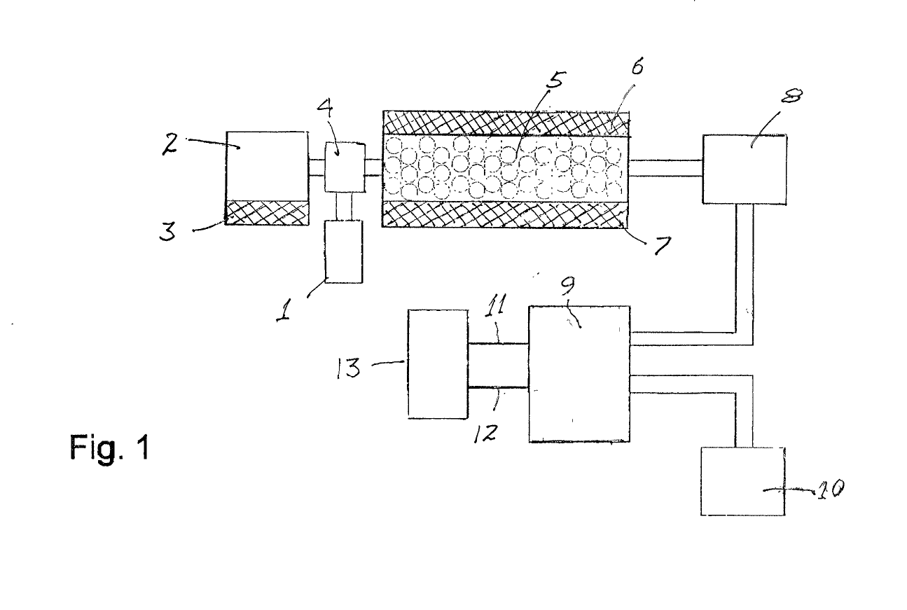

Referring to FIG. 1, a fuel-cell generating system is shown schematically using liquified propane (LP), or other liquified hydrocarbon fuel stored in a tank 1 customarily used in RVs and steam from a boiler 2 heated by a heat source 3. A fuel delivery system 4 combines the gaseous hydrocarbon fuel with the steam and delivers the mixture into a reforming catalyst bed 5 in a sealed cylinder 6 surrounded by a heat source 7 to supplement the heat of the steam for optimum reaction of the hydrocarbon fuel and steam with the catalyst. The reaction that takes place in the catalyst bed is:

XCₘHₙ+YH₂O →ZH₂+TCO+UCO₂

where the letters X, Y, Z, T and U represent numbers necessary for a balanced equation that depends upon the gaseous hydrocarbon employed as specified by the subscripts m and n, which for propane are 3 and 8, respectively.

The outflow of the reformer is passed through a purifier 8 which may be one of several types, including partial oxidation of CO to form CO₂ and membrane separation of CO₂ molecules from the hydrogen-rich stream. After purification, the pure hydrogen is fed to the PEM fuel cell 9 with air from a source 10

The action taking place in the PEM fuel cell 9 is production of DC electricity on electrodes 11 and 12 which can be used to power any DC load 13, or any AC load through respective DC-to DC or a DC-to-AC converters (not shown). A byproduct of the PEM fuel-cell operation is water that may then be stored aboard the RV as potable water for normal use. The primary product of the fuel cell is electricity derived by the proton-exchange membrane (PEM) in the fuel cell from the hydrogen ions (H+).

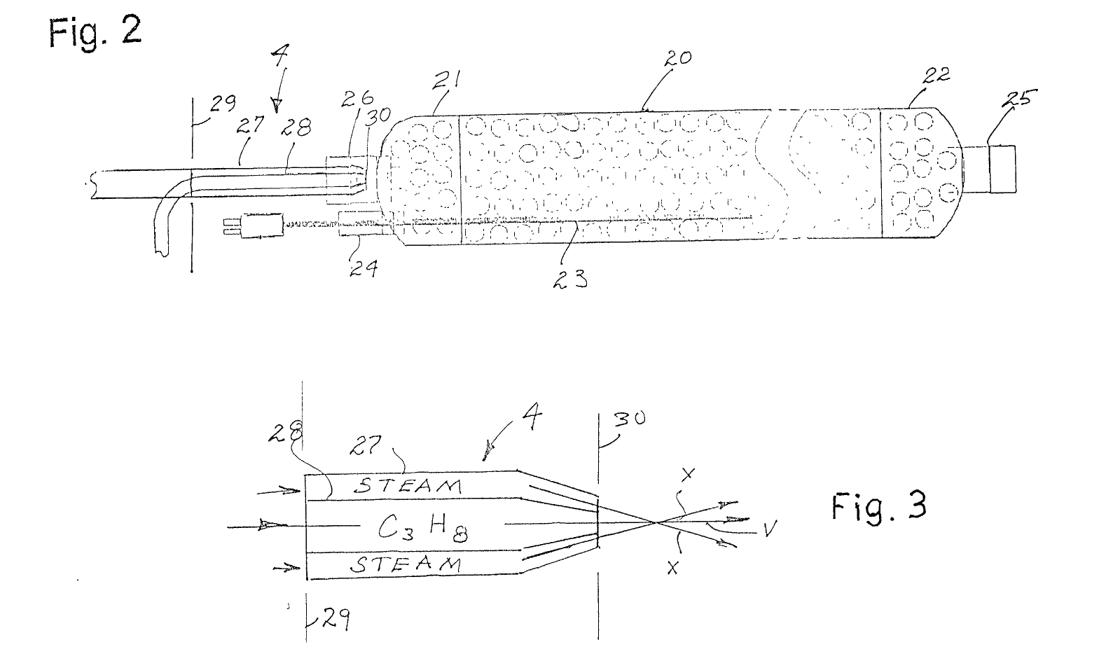

The role of the delivery system 4 shown in FIG. 1 for the gaseous hydrocarbon and steam is to enable the reformer to provide a high yield of hydrogen as will now be described in detail with reference to FIG. 2. Steam and gaseous hydrocarbon are introduced into the reforming catalyst bed in a stainless steel cylinder 20 surrounded by a suitable source of heat as described with reference to FIG. 1. In practice, the catalyst bed is made up of loosely packed catalyst pellets in the stainless steel cylinder 20 closed at its two ends by welded caps 21 and 22. A thermocouple 23 is installed in the catalyst bed through a compression fitting 24 for monitoring the temperature of the catalyst bed in order to regulate its temperature. A compression fitting 25 is welded to the end cap 22 for connection of an outflow tube that feeds the reaction products H₂, CO and CO₂ to the purifier 8 shown in FIG. 1.

A similar compression fitting 26 is welded to the end cap 21 for coupling the hydrocarbon fuel and steam into the catalyst packed cylinder 20 through the delivery system 4 shown in FIG. 1. As shown in FIG. 2, that delivery system comprises coaxial tubes 27 and 28. The tube 27 is shown schematically to be gradually reduced in diameter at its outflow end thereby providing a truncated cylindrical end even with the outflow of the tube 28. In other words, the ends of both tubes are positioned in a plane 30 perpendicular to their common axis.

Both tubes 27 and 28 may be provided with a truncated conical end. To accomplish that, a section of tube is cut to serve as the tube 27 of a length from a plane 29 to the plane 30. A rod (not shown) having a truncated conical tip and an external diameter slightly less than that of the internal diameter of the tube 27 so that it may be inserted with the truncated conical tip even with the end of the tube 27. That end of the tube 27 is then swagged by placing a tool having a conical cavity over the truncated conical tip, thus bending the end of the tube to conform to the truncated conical tip of the rod, thereby providing a gradually reducing inner diameter of the tube 27. A section of the tube 28 is similarly cut and swagged to gradually reduce its internal diameter but at a lower rate from the base of its truncated cylindrical tip to its end. That section of the tube 28 is welded with four equally spaced longitudinal fins (not shown) to hold its position in axial alignment with the tube 27 and with its outflow end positioned in the plane 30. The result is gradually reducing annular space between the tube 27around the inner tube 28 at their truncated conical tips for the steam to pass, thus forming an annular passage gradually decreasing in diameter that increases the steam velocity and thus lowers the pressure of the steam at the end of the inner tube 28, thereby producing a Venturi effect to draw out low-pressure hydrocarbon fuel from the tube 28 by providing a truncated conical shape to the tube 28 the velocity of the gaseous hydrocarbon is also increased, but that is not necessary if the diameter of that inner tube 28 is selected to provide an annular space between its end and the truncated conical end of the outer tube 27. In either case, the direction of the steam at all radial points of the tube 27 is toward the axis of the inner tube 28, which is the center of the core of gaseous hydrocarbon fuel outflow, i.e., it momentum vector V from the inner tube 28. The crossing momentum vectors X of steam with the momentum vector V of gaseous hydrocarbon effects a very thorough mixture of the steam with the gaseous hydrocarbon at the point where that mixture enters the end cap 21 of the reformer cylinder 20. That makes possible higher flow of the gaseous hydrocarbon and steam for optimized yield of hydrogen from the reformer.

Once the section of tube 28 is placed inside the section of tube 27, with the supporting fins of stainless steel spaced at 90° to each other, the ends of both tubes are coaxially spaced. The outflow end of the coaxially spaced tubes are connected to the welded caps 21 of the cylinder 20 by the compression fitting 26 to hold the tube 28 coaxially aligned in the tube 27. Thereafter, an extension 27′ of the section of the outer tube 27 is welded to its inflow end, but first a notch is made in that extension to accommodate a bent extension 28′ of the inner tube which is also welded to its inflow end so that it can be provided with gaseous hydrocarbon.

In practice, the gaseous propane and steam delivery system 4 was fabricated in the following manner basically using parts that were on-hand. All materials used were 316 Stainless Steel. Heli-arc welding was used on every weld. Used were two front ferrules, one with ⅛″ ID and another with ⅜″ ID. The ⅛″ Ferrule was butt-welded to the end of a ¼″ OD tube 28. The ⅜″ ferrule was butt-welded to the end of a ½″ OD tube 27. The ferrules were aligned on the ends of the tubes using a clamp which held two sides of the ferrule-tube joint while the open sides were tack-welded to hold the alignment. Then the full welds were done. The welded joints were then ground and polished to the same OD as the tube. Next, a hole was drilled in the

1/2″ tube 27 about 4-5″ from the top. This hole was drilled at roughly a 30° angle to accommodate the 1/r″ tube 28 being pushed up through it to the open end of the ½″ tube 27 (with the ferrule welded on it). The ¼″ tube was aligned flush with the end of the ½″ tube and centered. Centering was done by placing a rod inside the ¼″ tube and centering it in the ½″ tube by eye. The ⅛″ tube was held centered using a clamp and tack welds were made. The ¼″ tube was then realigned (again by eye) to make sure it was centered. Then the weld between the ⅛″ tube and the ½″ tube was finished at the hole drilled at a 30° angle. The inner tube 27 was cantilevered from the inner wall of the ½″ tube.

Although particular embodiments of the invention have been described an illustrated herein with reference to propane, it is recognized that methane and other gaseous hydrocarbons like butane may be alternatively used and that other modifications may readily occur to those skilled in the art. Consequently, it is intended that the claims be interpreted to cover such modifications and equivalents thereof.

What is claimed is:

1. A reformer for a mixture of low-pressure hydrocarbon gas and steam for fueling a proton-exchange fuel cell with hydrogen from said mixture, comprising
a cylinder loosely packed with a pelletized catalyst with a cap at each end,
a fuel tube for introducing said hydrocarbon gas into said cylinder at low pressure having an outflow end coupled to said cylinder through a cap at one end of said cylinder,
a steam tube coaxial with said fuel tube and surrounding said fuel tube for introducing steam at a pressure higher than said low pressure hydrocarbon gas through said cap at said one end of said cylinder, said steam tube having a tip of finite length at its outflow end that is gradually reduced in diameter over its length to form a truncated conical tip, with its open end of smaller diameter than said steam tube diameter forming an outflow end for said fuel tube, and
an outflow tube protruding outwardly from said cylinder through an end cap at an end of said cylinder opposite said one end,
wherein said steam tube extends to said outflow end of said fuel tube not only for flowing steam to draw out said low-pressure hydrocarbon gas for mixing with said steam, but qlso flows through a core of said fuel outflow in a direction that is at an acute angle with the direction of fuel outflow core, which is substantially along the axis of said coaxial fuel and steam tubes, thereby causing steam to cross said fuel outflow at an acute angle from all radial directions,
whereby said hydrocarbon gas and steam mix before coming in contact with said loosely packed pelletized catalyst as steam and fuel mixture flows over said catalyst through said cylinder to produce a high yield of H₂, as said hydrocarbon gas is converted into a flow of H₂, CO and CO₂ through said outflow tube of said cylinder.

2. A hydrocarbon gas and steam reformer as defined in claim 1 wherein said fuel tube has a tip of finite length at its outflow end that is reduced in diameter gradually along said finite length.

3. A hydrocarbon gas and steam reformer as defined in claim 1 wherein said hydrocarbon gas is low pressure propane, stored as liquified propane in a container for safe use aboard recreational vehicles.

4. A hydrocarbon gas and steam reformer as defined in claim 1 including a heat source around said cylinder for heating said catalyst.
